(19) United States
(12) Patent Application Publication
(10) Pub. No.: US 2024/0383108 A1
(43) Pub. Date: Nov. 21, 2024

(54) ADJUSTABLE LOCKING PLIERS

(71) Applicant: Apex Brands, Inc., Apex, NC (US)

(72) Inventors: Zhihong Fu, Cary, NC (US); Jonathan Eziquiel-Shriro, St. Louis, MO (US)

(21) Appl. No.: 18/569,913

(22) PCT Filed: Jun. 16, 2022
(86) PCT No.: PCT/US2022/033765

§ 371 Date: Dec. 13, 2023

Related U.S. Application Data
(60) Provisional application No. 63/211,223, filed on Jun. 16, 2021.

(51) Int. Cl. B25B 7/12; B25B 7/04

(52) U.S. Cl. CPC B25B 7/123; B25B 7/04

(57) ABSTRACT

A hand tool includes a handle assembly, a jaw assembly, and an adjustment assembly. The handle assembly may include a top handle and a bottom handle. The jaw assembly may include a top jaw and a bottom jaw. The adjustment assembly may be adjustable to change a bite size defined by the jaw assembly. The adjustment assembly may include a first adjuster disposed at a distal end of the top handle, a second adjuster disposed at a point between a middle portion and proximal end of the top handle, an adjustment rod operably coupled to each of the first and second adjusters, and a cross link extending between a portion of the bottom jaw or bottom handle and the adjustment rod.

### TECHNICAL FIELD

Example embodiments generally relate to hand tools and, in particular, relate to a pliers that can be easily adjusted due to the provision of multiple adjustment options.

### BACKGROUND

Hand tools are commonly used across all aspects of industry and in the homes of consumers. Hand tools are employed for multiple applications including, for example, tightening, component joining, and/or the like. For some applications, a locking pliers may be preferred. These familiar hand tools typically include jaws that can be locked into position after passing an over-center or other balance or tipping point position. In this regard, the jaws can effectively be locked in a clamping position and will remain closed in the clamping position after being locked until some unlocking action or force is initiated.

Modern conventional locking pliers often include an adjustment assembly, which enables the distance between the top and bottom jaws when the pliers is locked to be adjusted. The adjustment is conventionally made via a screw that is located at a distal end of the top handle (relative to the jaws). In this regard, the adjusting screw extends out of the distal end of the top handle and must be adjusted either when no gripping action is taking place or, if during a gripping action, by the hand opposite the hand engaging the locking pliers for the gripping action. Since it is not uncommon for users to attempt to size the distance between jaws dynamically while preparing to engage in a gripping operation, using two hands to adjust the locking pliers effectively becomes almost a rule.

In addition to being more complicated, two-hand operation of the locking pliers may be impractical for certain operations (e.g., where the operator needs to hold another piece of equipment or a pipe or component that is to be gripped with the locking pliers). Nevertheless, the two-hand operation method is very familiar to many users, and may actually be preferred by some. Thus, it may be desirable to provide a structure for a locking pliers that improves the ability of an operator to adjust the locking pliers, perhaps even with the use of just one hand.

### BRIEF SUMMARY OF SOME EXAMPLES

In an example embodiment, a hand tool may be provided. The hand tool may include a handle assembly, a jaw assembly, and an adjustment assembly. The handle assembly may include a top handle and a bottom handle. The jaw assembly may include a top jaw and a bottom jaw. The top and bottom jaws may be operably coupled to the top and bottom handles to compress the top and bottom jaws toward each other responsive to compression of the top and bottom handles toward each other. The adjustment assembly may be adjustable to change a bite size defined by the jaw assembly. The adjustment assembly may include a first adjuster disposed at a distal end of the top handle, a second adjuster disposed at a point between a middle portion and proximal end of the top handle, an adjustment rod operably coupled to each of the first and second adjusters, and a cross link extending between a portion of the bottom jaw or bottom handle and the adjustment rod. Rotating either the first adjuster or the second adjuster correspondingly rotates the adjustment rod to change a point of intersection of the cross link and the adjustment rod along a longitudinal length of the adjustment rod without moving the adjustment rod along a longitudinal axis of the top handle.

In another example embodiment, a hand tool may be provided. The hand tool may include a handle assembly, a jaw assembly, and an adjustment assembly. The handle assembly may include a top handle and a bottom handle. The jaw assembly may include a top jaw and a bottom jaw. The top and bottom jaws may be operably coupled to the top and bottom handles to compress the top and bottom jaws toward each other responsive to compression of the top and bottom handles toward each other. The adjustment assembly may be adjustable to change a bite size defined by the jaw assembly. The adjustment assembly may include an adjustment rod, an adjuster disposed at a distal end of the top handle and operably coupled to the adjustment rod, and a cross link extending between a portion of the bottom jaw or bottom handle and the adjustment rod. In such an example, the adjuster may include an eyelet from which the hand tool is suspendable via a tether. Rotating the adjuster may correspondingly rotate the adjustment rod to change a point of intersection of the cross link and the adjustment rod along a longitudinal length of the adjustment rod without moving the eyelet axially toward or away from the distal end of the top handle.

In still another example embodiment, a hand tool may be provided. The hand tool may include a handle assembly, a jaw assembly, and an adjustment assembly. The handle assembly may include a top handle and a bottom handle. The jaw assembly may include a top jaw and a bottom jaw. The top and bottom jaws may be operably coupled to the top and bottom handles to compress the top and bottom jaws toward each other responsive to compression of the top and bottom handles toward each other. The adjustment assembly may be adjustable to change a bite size defined by the jaw assembly. The adjustment assembly may include a first adjuster disposed at a distal end of the top handle, a second adjuster disposed at a point between a middle portion and proximal end of the top handle, an adjustment rod operably coupled to each of the first and second adjusters, and a cross link extending between a portion of the bottom jaw or bottom handle and the adjustment rod. The second adjuster may extends through a window portion disposed in the top handle. The second adjuster may exert a force on the top handle at the window portion responsive to rotation of the adjustment rod to change a point of intersection of the cross link and the adjustment rod along a longitudinal length of the adjustment rod to change the bite size.

In yet another example embodiment, a hand tool may be provided. The hand tool may include a handle assembly, a jaw assembly, and an adjustment assembly. The handle assembly may include a top handle and a bottom handle. The jaw assembly may include a top jaw and a bottom jaw. The top and bottom jaws may be operably coupled to the top and bottom handles to compress the top and bottom jaws toward each other responsive to compression of the top and bottom handles toward each other. The adjustment assembly may be adjustable to change a bite size defined by the jaw assembly. The adjustment assembly may include an adjuster accessible through a window portion disposed in the top handle, an adjustment rod operably coupled to the adjuster to rotate with the adjuster, and a cross link extending between a portion of the bottom jaw or bottom handle and the adjustment rod. A torsion spring may be disposed between the bottom jaw and the cross link to assist increasing and decreasing the bite size via rotation of the adjuster with a same hand that grips the hand tool.

In yet still another example embodiment, a hand tool may be provided. The hand tool may include a handle assembly, a jaw assembly, an adjustment assembly and a locking assembly. The handle assembly may include a top handle and a bottom handle. The jaw assembly may include a top jaw and a bottom jaw. The top and bottom jaws may be operably coupled to the top and bottom handles to compress the top and bottom jaws toward each other responsive to compression of the top and bottom handles toward each other. The adjustment assembly may be adjustable to change a bite size defined by the jaw assembly. The locking assembly may be operably coupled to the bottom handle to lock a grip of the hand tool at the bite size responsive to actuation of the locking assembly. The locking assembly may include a locking lever and a locking spring. The locking lever may include a body portion that extends substantially within a channel formed in the bottom handle and an unlocking tab that is operable to actuate the locking assembly. A shoulder portion may be disposed at a transition between the body portion and the unlocking tab to provide tactile feedback to an operator of the hand tool to indicate a location at which the unlocking tab interfaces with the bottom handle when the locking assembly is actuated.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a side view of a hand tool with an improved adjustment assembly according to an example embodiment;

FIG. 2 is a perspective view of the pliers in cross section according to an example embodiment;

FIG. 3 is a side view of the pliers with a top handle thereof removed to expose internal components and connections according to an example embodiment;

FIG. 4 illustrates an isolated perspective view of internal components the pliers according to an example embodiment;

FIG. 5, which is defined by FIGS. 5A and 5B, illustrates isolated perspective views of the bottom handle of the pliers along with the locking lever according to an example embodiment;

FIG. 6, which is defined by FIGS. 6A and 6B, illustrates an exploded perspective view of the top handle of the pliers according to an example embodiment;

FIG. 7 shows an exploded view of the adjustment assembly to show perspective views of various components that form the adjustment assembly according to an example embodiment; and

FIG. 8, which is defined by FIGS. 8A and 8B, illustrates perspective views of a spring in the adjustment assembly of the pliers according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

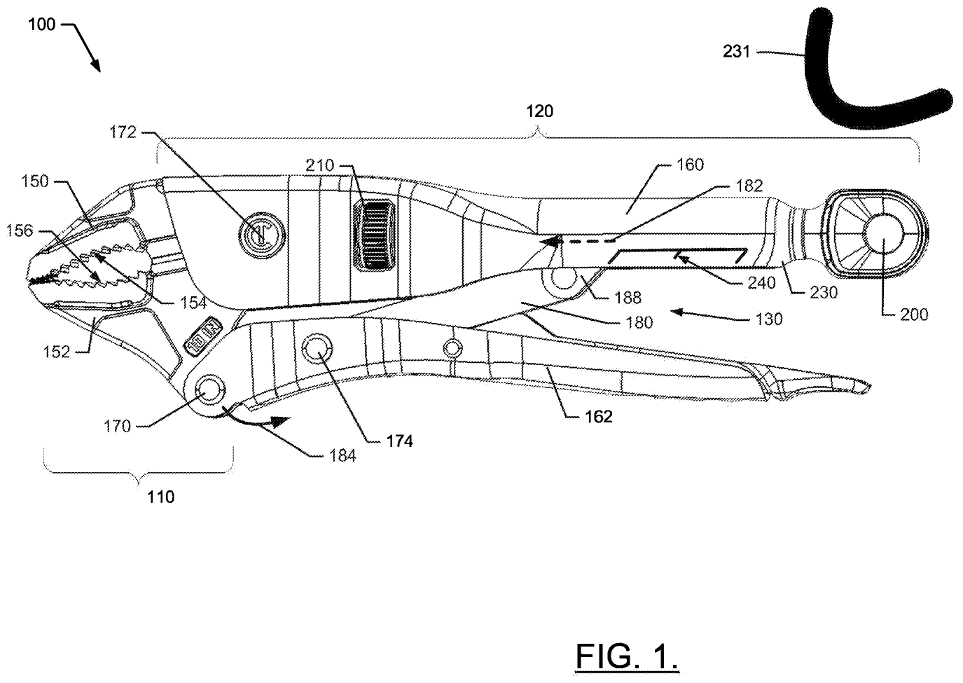

As indicated above, some example embodiments may relate to the provision of a pliers that can be adjusted (i.e., relative to its bite or grip size) more easily, and possibly even with the same hand that is applying a grip to the handles of the pliers. Some example embodiments may provide multiple adjustment options for changing the grip size of the pliers. In this regard, a first adjuster may be disposed at a rear portion (relative to the jaws) of the top handle. Although including the general function of a conventional locking pliers as described above, example embodiments may further include structure for adding another function (e.g., means for hanging the pliers during storage). Meanwhile, a second adjuster may be disposed at an opposite end of a grip portion of the pliers relative to the first adjuster (e.g., proximate to the jaws). FIGS. 1-8 show various views or portions of one example of a pliers capable of grasping media while still being easily adjustable.

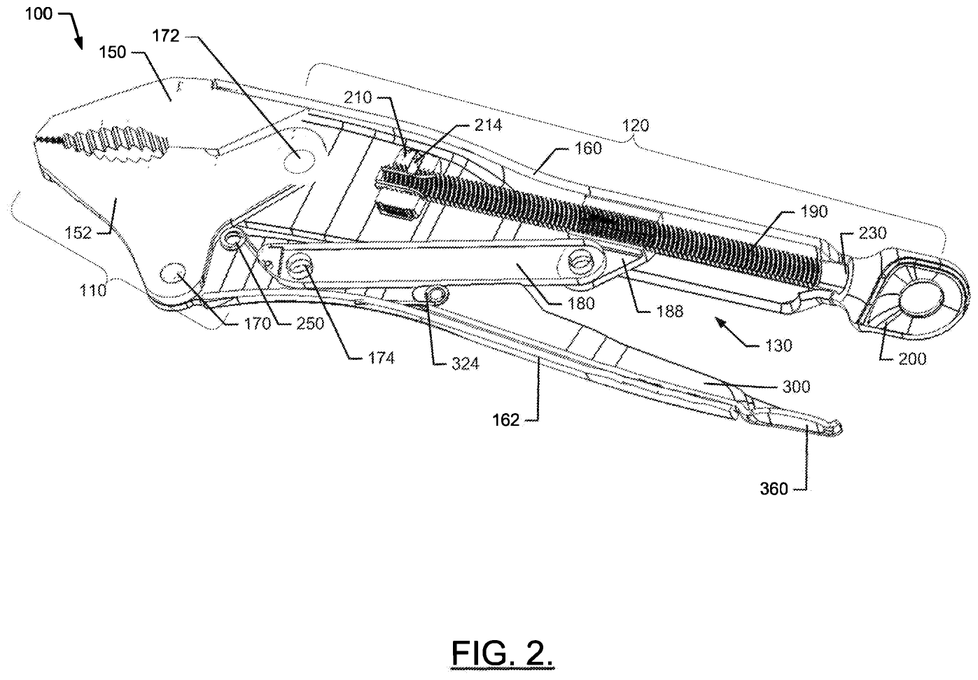

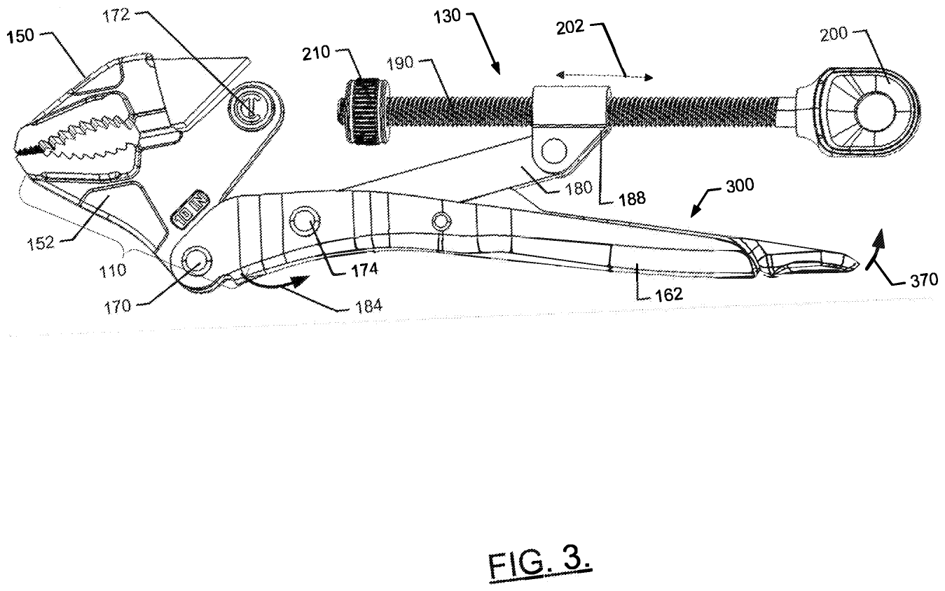

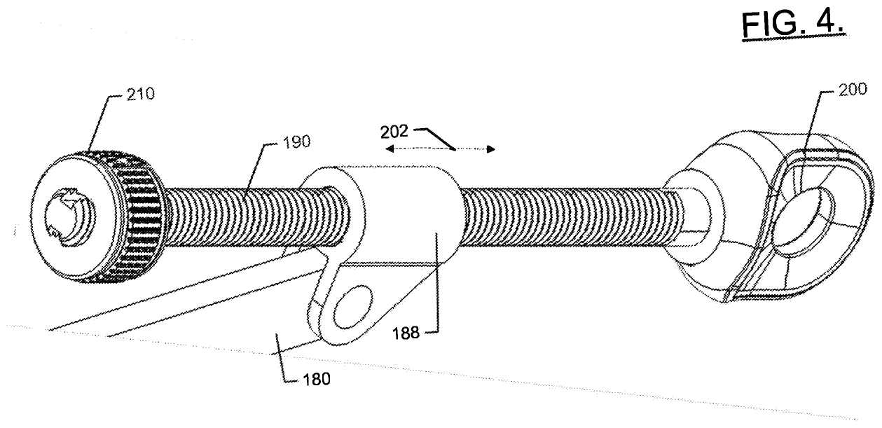

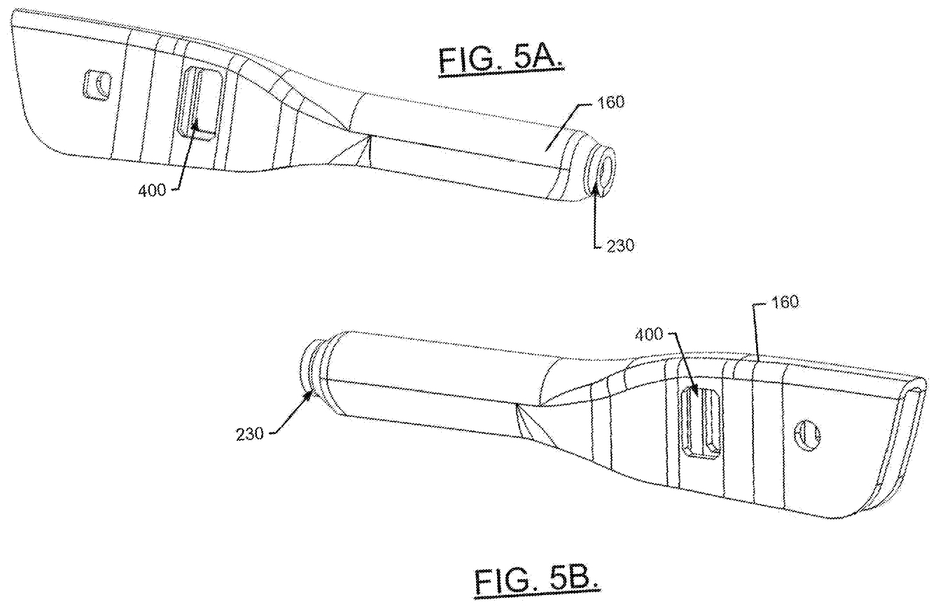

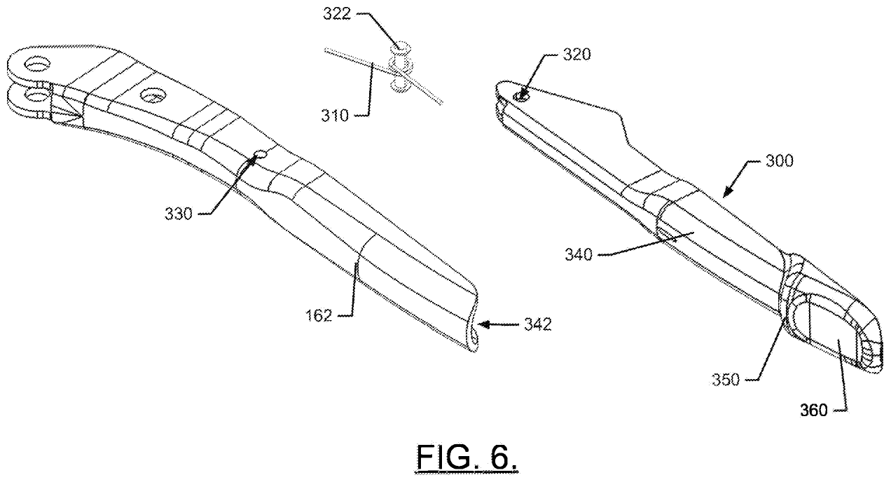

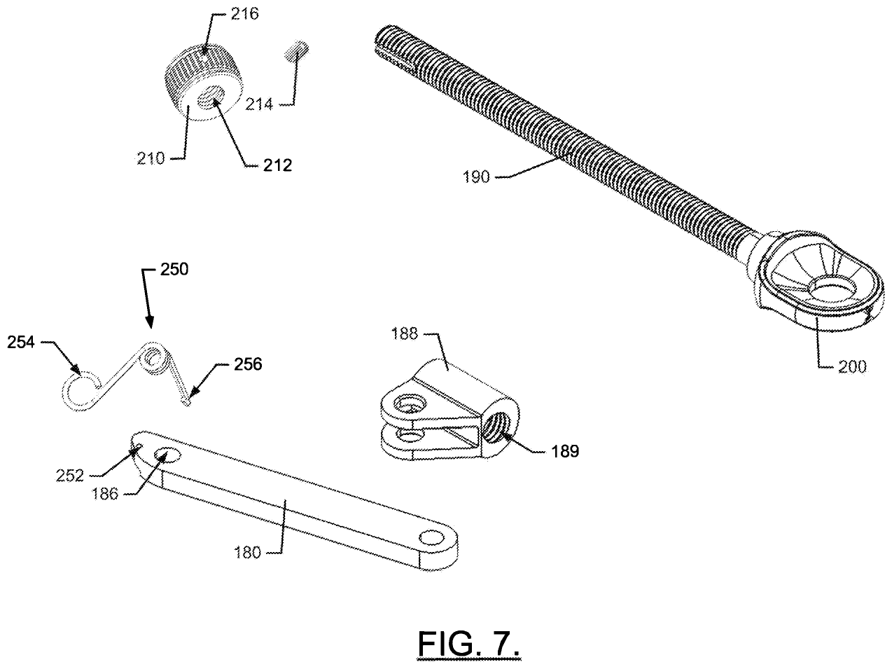

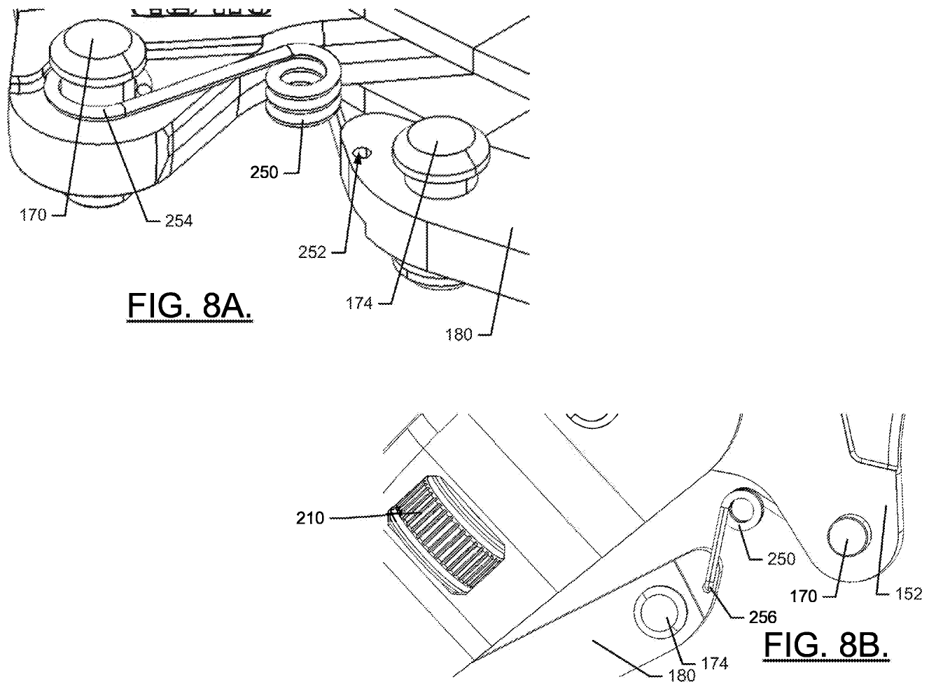

In this regard, FIG. 1 illustrates a side view of a pliers 100 of an example embodiment. FIG. 2 is a perspective view of the pliers 100 in cross section, with the sectioning passing through a longitudinal centerline of the pliers 100 and dividing the pliers 100 into substantially equal right and left halves. The right half is shown in FIG. 2. FIG. 3 is a side view of the pliers with a top handle thereof removed to expose internal components and connections. FIG. 4 illustrates an isolated perspective view of some of those internal components the pliers 100. FIG. 5, which is defined by FIGS. 5A and 5B, illustrates isolated perspective views of the top handle of the pliers 100. FIG. 6, which is defined by FIGS. 6A and 6B, illustrates an exploded perspective view of the top handle of the pliers 100 according to an example embodiment. FIG. 7 shows perspective views of various components that form the adjustment assembly according to an example embodiment. FIG. 8, which is defined by FIGS. 8A and 8B, illustrates perspective views of a spring in the adjustment assembly of the pliers according to an example embodiment.

Referring now to FIGS. 1-8, the pliers 100 may include a jaw assembly 110 at a first end thereof (e.g., a front end thereof). The pliers 100 may also include a handle assembly 120 at a second end thereof (e.g., a rear end thereof). Notably, there may be some overlap between the jaw assembly 110 and the handle assembly 120 by virtue of the way they are operably coupled to each other. An adjustment assembly 130 may be integrated into the handle assembly 120 to adjust a grip or bite size of the jaw assembly 110 via one or two handed operation.

The jaw assembly 110 may include a top jaw 150 and a bottom jaw 152 that are configured to face each other with at least one of the top jaw 150 or bottom jaw 152 being movable relative to the other in order to define open and closed positions as defined in greater detail below. Although not required, the top jaw 150 may include an arcuate shaped grip portion 154 that extends from a distal end of the top jaw 150 (relative to the handle assembly 120) toward the handle assembly 120. The grip portion 154 may include transversely extending teeth of similar or different sizes relative to one another. The bottom jaw 152 may also include an arcuate shaped grip portion 156 that extends from a distal end of the bottom jaw 152 (relative to the handle assembly 120). The grip portion 156 may also include transversely extending teeth of similar or different sizes relative to one another (and to the teeth of the grip portion 154 of the top jaw 150). In some cases, the distal ends of the grip portions 154 and 156 may not be arcuate, and may instead be substantially parallel to each other when in the jaw assembly 110 is in the closed position. Media may be placed between the top jaw 150 and bottom jaw 152, and the media may be gripped by the grip portions 154 and 156 via operation of the handle assembly 120.

The handle assembly 120 may include a top handle 160 and a bottom handle 162. In an example embodiment, the handle assembly 120 and the jaw assembly 110, and components thereof, may be pivotally connected to each other via a series of pivot links. For example, the bottom jaw 152 and the bottom handle 162 may be pivotally connected to each other via a first pivot link 170. The top handle 160 and the bottom jaw 152 may be pivotally connected to each other via a second pivot link 172. The top handle 160 and the bottom handle 162 may be operably coupled to each other via a cross link 180. A first end of the cross link 180 may be pivotally connected to the bottom handle 162 at a third pivot link 174, which is disposed at a fixed location on the bottom handle 162. Meanwhile, a second end of the cross link 180 is operably coupled to the top handle 160 at a non-fixed or movable location along the length of the top handle 160. When the handle assembly 120 is compressed (e.g., the top and bottom handles 160 and 162 are compressed toward each other), the pivot links may cooperate to cause the grip portions 154 and 156 of the top and bottom jaws 150 and 152, respectively, to be drawn toward each other. When the handle assembly 120 is released, the top and bottom jaws 150 and 152 may extend apart from each other.

Movement of the variable location at which the cross link 180 intersects with the top handle 160 is accomplished via the adjustment assembly 130, and adjusts the bite or grip size of the jaw assembly 110 by effectively moving an orientation of the first and second pivot links 170 and 172 relative to each other. In this regard, for example, as the location at which the cross link 180 intersects with the top handle 160 moves forward (e.g., in the direction of arrow 182), the first pivot link 170 is moved rearward as shown by arrow 184. The rearward movement of the first pivot link 170 tends to open the bottom jaw 152 relative to the top jaw 150.

The adjustment assembly 130 may include the cross link 180 and adjustment rod 190, which further comprises a first adjuster 200 and interfaces with a second adjuster 210. Notably, the cross link 180 is not directly connected to the top handle 160 to define the intersection therewith. Instead, the cross link 180 is operably coupled to the adjustment rod 190, and the adjustment rod 190 is rotatable to move the point of intersection between the adjustment rod 190 and the cross link 180 (e.g., in the directions shown by double arrow 202 of FIGS. 3 and 4) along the longitudinal axis of the top handle 160 (and the longitudinal axis of the adjustment rod 190) to effectively change the position at which the cross link 180 engages the top handle 160. In this regard, the cross link 180 may include a link receiver 186 at one end thereof, and may include an adjustment rod interface member 188 at the other end thereof. The link receiver 186 may receive the third pivot link 174 to operably couple the cross link 180 to the bottom handle 162. Meanwhile, the adjustment rod interface member 188 may be formed with a threaded channel 189 that is in threaded engagement with the adjustment rod 190. Thus, responsive to rotation of the adjustment rod 190, the adjustment rod interface member 188 will move along the adjustment rod 190 in one of the directions shown by double arrow 202 depending on the direction of rotation of the adjustment rod 190.

In an example embodiment, the adjustment rod 190 be threaded over all or a significant portion of the adjustment rod 190 that is disposed between the first adjuster 200 and a portion of the adjustment rod 190 that interfaces with the second adjuster 210. The adjustment rod 190 (which may include the threaded portion of the adjustment rod 190) may pass through a collar 230 that may be disposed at a distal end of the top handle 160. The collar 230 may, however, not be threaded, so no threaded engagement is provided between the collar 230 and the adjustment rod 190. Accordingly, as can be appreciated from the description above, rotating the first adjuster 200 in one direction causes rotation of the adjustment rod 190 (e.g., to permit the adjustment rod interface member 188 to move along the adjustment rod 190 one way), but does not cause the first adjuster 200 to extend further out the distal end of the top handle 160, or extend closer to the collar 230. Instead, the relative location of the first adjuster 200 to the collar 230 does not change with rotation of the adjustment rod 190. Meanwhile, rotating the first adjuster 200 in the opposite direction causes the adjustment rod interface member 188 to move along the adjustment rod 190 opposite the one way noted above, while the first adjuster 200 again is not drawn into the distal end of the top handle 160, but stays at the same location relative to the collar 230.

The first adjuster 200 of this example takes the form of an eyelet. Since the first adjuster 200 is an eyelet, a screw driver or other implement can easily be passed through the eyelet to facilitate turning the first adjuster 200. However, the eyelet also provides an additional functional capability of enabling the pliers 100 to be stored or suspended via the eyelet (e.g., on a hook, nail or other projection). A tether 231 may also be passed through the eyelet of the first adjuster 200 to operably couple the pliers 100 to a belt or other portion of a worker who may be working in an elevated condition. The tether 231 may prevent the pliers 100 from falling to damage equipment or injure personnel during working in such an elevated condition.

The adjustment rod interface member 188, or a portion of the cross link 180, may pass through an opening (e.g., a U shaped channel) in a bottom portion of the top handle 160. When viewed from the side (as shown in FIG. 1), a rear portion of the adjustment rod interface member 188 (or the cross link 180) may appear to intersect with the top handle 160. In an example embodiment, a bite size indicator 240 may be formed as graduated markings disposed along a portion of the top handle 160 located forward of the collar 230. The point of apparent intersection of the rear part of the adjustment rod interface member 188 (or the cross link) and the bite size indicator 240 may be proportional to (or directly indicate) a distance between the distal ends of the grip portions 154 and 156 (and therefore the bite size for the top and bottom jaw 150 and 152 of the pliers 100.

The second adjuster 210 of this example takes the form of a rotatable nut-like actuator that is rotatably captured in a portion of the top handle 160. The second adjuster 210 may therefore, for example, have teeth or other surface features that are relatively easy to grip disposed on an outer peripheral surface thereof. Meanwhile, the second adjuster 210 may also be structured to interface with the adjustment rod 190 to cause the adjustment rod 190 to rotate about its axis to cause the adjustment rod interface member 188 to move along the adjustment rod 190 as noted above. In particular, in this example, the second adjuster 210 is formed to have a threaded channel 212 formed at a center of the second adjuster 210 and may be threaded onto the adjustment rod 190 during assembly. However, after such threading, a pin 214 may be extended into a radial channel 216 that passes through the second adjuster 210 to engage the adjustment rod 190. The pin 214 is merely one example of a means by which to affix the second adjuster 210 to the adjustment rod 190, however, and other means could be used as an alternative. For example, the second adjuster 210 could be welded to the adjustment rod 190 in some cases. Regardless of how connected, the second adjuster 210 may carry the adjustment rod 190 therewith, when the second adjuster 210 is rotated by a finger (e.g., the thumb) of the operator. Thus, for the particular design shown, there is a 1:1 ratio for turning of the first adjuster 200 and turning of the second adjuster 210. In other words, one turn of the first adjuster 200 is equivalent to one turn of the second adjuster 210, and vice versa. Also, one turn of either the first adjuster 200 or the second adjuster 210 causes one turn of the adjustment rod 190. However, there is no axial movement of the adjustment rod 190 within the top handle 160 (or relative to the collar 230). Instead, rotation of the adjustment rod 190 only causes movement of the adjustment rod interface member 188 along the adjustment rod 190. Such movement causes a force to be exerted at the cross link 180 on the bottom handle 162 and therefore also movement of the bottom jaw 152 to adjust the bite size of the pliers 100.

The adjustment rod interface member 188 slide along the adjustment rod 190 as noted above. A spring 250 may extend from the bottom jaw 152 to the cross link 180 to facilitate opening and closing of the pliers 100. In this regard, the cross link 180 may have a spring retainer 252 formed proximate to where the third pivot link 174 engages the link receiver 186. The spring 250 may extend between the first link 170 (e.g., being wrapped around the first link 170 at a first end 254 of the spring 250) and the spring retainer 252, which may be connected to the spring retainer 252 at a second end 256 of the spring 250. The spring 250 may be a torsion spring that has a neutral position and can be compressed or extended away from the neutral position in opposing directions. Thus, when either compressed or extended, the spring 250 will tend to oppose such movement and bias the components attached by the spring 250 to return to the neutral position. When the bite size is minimum (i.e., when the distal ends of the grip portions 154 and 156 touch each other), the spring 250 may be compressed, and may provide biasing toward the neutral position. This biasing may make adjustment of the bite size (i.e., enlarging in this case) easier since the biasing provides force to assist opening the pliers 100. Meanwhile, when the bite size is maximum (i.e., when the distal ends of the grip portions 154 and 156 farthest apart from each other), the spring 250 may be extended, and may provide biasing toward the neutral position. This biasing may make adjustment of the bite size (i.e., making the bite size smaller in this case) easier since the biasing provides force to assist closing the pliers 100. Thus, the spring 250 is configured to ease any resistant forces on the second adjuster 210 to facilitate one handed adjustment of the bite size. The neutral position that is defined between the bottom handle 162 and the cross link 180 may therefore bias the spring 250 to generate force to lock or unlock the bottom jaw relative to the cross link based on which side of the neutral position the bottom jaw and cross link are on. In other words, the spring 250 may be compressed to force the bottom handle 162 and the cross link 180 to lock or unlock automatically depending on which side of the neutral position the bottom handle 162 and the cross link 180 are on, without regard to the bite size of the jaws, or locking state of the handles. When closing the bottom handle 162 to lock, the spring 250 may pass the neutral position and force the bottom handle 162 and the cross link 180 to lock. When opening the bottom handle 162 to past the neutral position to unlock, the spring 250 will push the bottom handle 162 to a maximum angle relative to the cross link 180 (e.g., until fully open). The spring 250 provides force for opening and closing of the bottom handle 162 and the cross link 180 without dependence on the second adjuster 210, and without affecting the turning of the second adjuster 210.

In some embodiments, the bottom handle 162 may further include a locking assembly that includes a locking lever 300 and locking spring 310. The locking lever 300 may have a pin receiver 320 located at a proximal end thereof, and the pin receiver 320 may receive a pivot pin 322 about which the locking spring 310 (which may also be a torsion spring) may be wrapped. The pivot pin 322 may also pass through a pivot pin receiver 330 located at a middle portion of the bottom handle 162. The locking spring 310 may extend to exert force on the bottom handle 162 on one side thereof, and the locking lever 300 on the other side. Meanwhile, the locking lever 300 may include a body portion 340 that is sized to fit within a channel portion 342 of the bottom handle 162. At a distal end of the locking lever 300, a shoulder portion 350 may be formed to define a transition from the body portion 340 to an unlocking tab 360, which extends from the distal end of the bottom handle 162 and the channel portion 342. The shoulder portion 350 may extend to have a width substantially similar to the width of the bottom handle 162 at portions thereof that are proximate to the shoulder portion 350. Thus, the shoulder portion 350 provides a transition to the unlocking tab 360 that minimizes changes in width and depth between the distal end of the bottom handle 162 and the unlocking tab 360. The shoulder portion 350 also provides tactile feedback to the operator to inform the operator as to where the distal end of the bottom handle 162 can be expected to clamp toward the locking lever 300 when the locking assembly is locked. This tactile feedback may assist the operator in ensuring that his/her fingers are clear of the area opposite the unlocking tab 360 and proximate to the shoulder portion 350 to avoid any possible pinching of the operator's finger(s).

When the locking lever 300 is proximate to the bottom handle 162 in the closed position, the torsion spring 324 may facilitate locking the pliers 100 in the closed position. However, by pivoting the unlocking tab 360 in the direction of arrow 370 (see FIG. 3), the bottom handle 162 may be unlocked and a transition may occur to the open position.

As can be appreciated from the description above, as the adjustment rod 190 is rotated, but the design described herein prevents the adjustment rod 190 from extending further out the distal end of the top handle 160, or being drawn further into the top handle 160 during such rotation. Instead, the second end of the cross link 180 (i.e., the adjustment rod interface member 188) effectively engages (or intersects) the top handle 160 at a portion of the top handle 160 that is closer to the distal end of the top handle 160 due to movement of the adjustment rod interface member 188 along the adjustment rod 190. The orientation of the first pivot link 170 relative to the second pivot link 172, and the corresponding changes to bite size described above, are therefore caused by adjusting the position of the cross link 180 relative to the top handle 160 by rotating the first adjuster 200 or the second adjuster 210. This causes a corresponding change in the location of the intersection between the adjustment rod interface member 188 along the longitudinal length of the top handle 160 and the adjustment rod 190 (e.g., along a direction shown by double arrow 202).

Other than the first adjuster 200 being formed as an eyelet to add the additional function of enabling suspension of the pliers 100 via the first adjuster 200, and not moving in or out relative to the top handle 160 when rotated, the first adjuster 200 may operate similar to conventional locking pliers. In this regard, a two-hand adjustment of the bite size of the pliers 100 may be caused by operation of the first adjuster 200. However, the addition of the second adjuster 210 adds the further capability of one-hand adjustment and, in any case, allows two different ways by which the grip or bite size of the pliers can be adjusted. Moreover, the provision of spring 250 facilitates easy operation of the second adjuster 210 to change bite size for the pliers 100.

A window portion 400 formed in the top handle 160 may extend entirely through the sides of the top handle 160, but not the top or bottom. Thus, for example, the window portion 400 extends around four sides of the second adjuster 210, while leaving the other two sides of the second adjuster 210 exposed for operation by the operator. Moreover, the operator can grip the handle assembly 120 while using one finger (e.g., the thumb) to turn the second adjuster 210. Thus, the pliers 100 enables both one-hand operation (e.g., via the second adjuster 210) and two hand operation (e.g., via the first adjuster 200). The window portion 400 also fixes the location of the adjustment rod 190 in the top handle 160. In this regard, since the second adjuster 210 does not move axially relative to the adjustment rod 190 when rotated, but instead carries the adjustment rod 190 during such rotation (or is carried by the adjustment rod 190 during rotation of the first adjuster 200), the axial location of the adjustment rod 190 within the top handle 160 does not change during rotation of the adjustment rod.

The pliers 100 of FIGS. 1-8 is merely one example of a hand tool that may employ example embodiments. As can be appreciated from the example of FIGS. 1-8, example embodiments may define a hand tool with an improved capability for grasping media and adjusting the bite size of the jaws with the gripping hand or with two hands. In this regard, for example, a hand tool of an example embodiment may include a handle assembly, a jaw assembly, and an adjustment assembly. The handle assembly may include a top handle and a bottom handle. The jaw assembly may include a top jaw and a bottom jaw. The top and bottom jaws may be operably coupled to the top and bottom handles to compress the top and bottom jaws toward each other responsive to compression of the top and bottom handles toward each other. The adjustment assembly may be adjustable to change a bite size defined by the jaw assembly. The adjustment assembly may take a number of different forms. For example, in one embodiment, the adjustment assembly may include a first adjuster disposed at a distal end of the top handle, a second adjuster disposed at a point between a middle portion and proximal end of the top handle, an adjustment rod operably coupled to each of the first and second adjusters, and a cross link extending between a portion of the bottom jaw or bottom handle and the adjustment rod. Rotating either the first adjuster or the second adjuster correspondingly rotates the adjustment rod to change a point of intersection of the cross link and the adjustment rod along a longitudinal length of the adjustment rod without moving the adjustment rod along a longitudinal axis of the top handle.

In other example embodiment, the adjuster assembly may instead include an adjustment rod, an adjuster disposed at a distal end of the top handle and operably coupled to the adjustment rod, and a cross link extending between a portion of the bottom jaw or bottom handle and the adjustment rod. In such an example, the adjuster may include an eyelet from which the hand tool is suspendable via a tether. Rotating the adjuster may correspondingly rotate the adjustment rod to change a point of intersection of the cross link and the adjustment rod along a longitudinal length of the adjustment rod without moving the eyelet axially toward or away from the distal end of the top handle.

In yet another example embodiment, the adjustment assembly may include a first adjuster disposed at a distal end of the top handle, a second adjuster disposed at a point between a middle portion and proximal end of the top handle, an adjustment rod operably coupled to each of the first and second adjusters, and a cross link extending between a portion of the bottom jaw or bottom handle and the adjustment rod. The second adjuster may extends through a window portion disposed in the top handle. The second adjuster may exert a force on the top handle at the window portion responsive to rotation of the adjustment rod to change a point of intersection of the cross link and the adjustment rod along a longitudinal length of the adjustment rod to change the bite size.

In still another example embodiment, the adjustment assembly may include an adjuster accessible through a window portion disposed in the top handle, an adjustment rod operably coupled to the adjuster to rotate with the adjuster, and a cross link extending between a portion of the bottom jaw or bottom handle and the adjustment rod. A torsion spring may be disposed between the bottom jaw and the cross link to assist increasing and decreasing the bite size via rotation of the adjuster with a same hand that grips the hand tool.

In yet still another example embodiment, the hand tool may further include a locking assembly operably coupled to the bottom handle to lock a grip of the hand tool at the bite size responsive to actuation of the locking assembly. The locking assembly may include a locking lever and a locking spring. The locking lever may include a body portion that extends substantially within a channel formed in the bottom handle and an unlocking tab that is operable to actuate the locking assembly. A shoulder portion may be disposed at a transition between the body portion and the unlocking tab to provide tactile feedback to an operator of the hand tool to indicate a location at which the unlocking tab interfaces with the bottom handle when the locking assembly is actuated.

The hand tool and/or its components may include a number of modifications, augmentations, or optional additions, some of which are described herein. The modifications and augmentations may include combining the features of the hand tools (and particularly of the adjustment assemblies) described above. The modifications, augmentations or optional additions may be added in any desirable combination. For example, the top handle may include a bite size indicator disposed between the first and second adjusters to visually indicate a bite size of the jaw assembly. In an example embodiment, the bite size indicator may include graduated markings disposed along a portion of the top handle extending forward of the first adjuster. A point of intersection of the cross link or an adjustment rod interface member that operably couples the cross link to the adjustment rod with the graduated markings may indicate a distance proportional to a distance between distal ends of top and bottom jaws. In some cases, an adjustment rod interface member may operably couple the cross link to the adjustment rod. The adjustment rod interface member may include a threaded channel in threaded engagement with the adjustment rod. In an example embodiment, the first adjuster may include an eyelet from which the hand tool is suspendable via a tether. In some cases, the adjustment rod may extend out of the top handle through a collar, and the first adjuster may be disposed proximate to the collar and relative position of the first adjuster and collar may be substantially constant during rotation of the first adjuster to prevent withdrawal of the adjustment rod or first adjuster from engagement with the top handle. In an example embodiment, the second adjuster may extend through a window portion disposed in the top handle, and the second adjuster may exert a force on the top handle at the window portion responsive to rotation of the adjustment rod to change the point of intersection of the cross link and the adjustment rod. In some cases, the second adjuster may be affixed to the adjustment rod via a radially extending pin that passes through the second adjuster and into a portion of the adjustment rod. In an example embodiment, the bite size may be adjustable while a grip hand of an operator engages the top and bottom handles via only the grip hand using the second adjuster, and via adjustment of the first adjuster using a non-grip hand of the operator.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A hand tool comprising:
a handle assembly comprising a top handle and a bottom handle;
a jaw assembly comprising a top jaw and a bottom jaw, the top and bottom jaws being operably coupled to the top and bottom handles to compress the top and bottom jaws toward each other responsive to compression of the top and bottom handles toward each other; and
an adjustment assembly that is adjustable to change a bite size defined by the jaw assembly,
wherein the adjustment assembly comprises a first adjuster disposed at a distal end of the top handle, a second adjuster disposed at a point between a middle portion and proximal end of the top handle, an adjustment rod operably coupled to each of the first and second adjusters, and a cross link extending between a portion of the bottom jaw or bottom handle and the adjustment rod,
wherein rotating either the first adjuster or the second adjuster correspondingly rotates the adjustment rod to change a point of intersection of the cross link and the adjustment rod along a longitudinal length of the adjustment rod without moving the adjustment rod along a longitudinal axis of the top handle.

2. The hand tool of claim 1, wherein the top handle comprises a bite size indicator disposed between the first and second adjusters to visually indicate a bite size of the jaw assembly.

3. The hand tool of claim 2, wherein the bite size indicator comprises graduated markings disposed along a portion of the top handle extending forward of the first adjuster, and
wherein a point of intersection of the cross link or an adjustment rod interface member that operably couples the cross link to the adjustment rod with the graduated markings indicates a distance proportional to a distance between distal ends of top and bottom jaws.

4. The hand tool of claim 1, wherein an adjustment rod interface member operably couples the cross link to the adjustment rod, and
wherein the adjustment rod interface member comprises a threaded channel in threaded engagement with the adjustment rod.

5. The hand tool of claim 1, wherein the first adjuster comprises an eyelet from which the hand tool is suspendable via a tether.

6. The hand tool of claim 5, wherein the adjustment rod extends out of the top handle through a collar, and
wherein the first adjuster is disposed proximate to the collar and relative position of the first adjuster and collar is substantially constant during rotation of the first adjuster to prevent withdrawal of the adjustment rod or first adjuster from engagement with the top handle.

7. The hand tool of claim 1, wherein the second adjuster extends through a window portion disposed in the top handle, and
wherein the second adjuster exerts a force on the top handle at the window portion responsive to rotation of the adjustment rod to change the point of intersection of the cross link and the adjustment rod.

8. The hand tool of claim 1, wherein the second adjuster is affixed to the adjustment rod via a radially extending pin that passes through the second adjuster and into a portion of the adjustment rod.

9. The hand tool of claim 1, wherein a torsion spring is disposed between the bottom jaw and the cross link, the torsion spring having a neutral position and being biased to generate force to lock or unlock the bottom jaw relative to the cross link based on which side of the neutral position the bottom jaw and cross link are on.

10. The hand tool of claim 1, wherein the bottom handle further comprises a locking assembly including a locking lever and a locking spring,
wherein the locking lever comprises a body portion that extends substantially within a channel formed in the bottom handle and an unlocking tab that is operable to actuate the locking assembly, and
wherein a shoulder portion is disposed at a transition between the body portion and the unlocking tab to provide tactile feedback to an operator of the hand tool to indicate a location at which the unlocking tab interfaces with the bottom handle when the locking assembly is actuated.

11. The hand tool of claim 1, wherein the bite size is adjustable while a grip hand of an operator engages the top and bottom handles via only the grip hand using the second adjuster, and via adjustment of the first adjuster using a non-grip hand of the operator.

12. A hand tool comprising:
a handle assembly comprising a top handle and a bottom handle;
a jaw assembly comprising a top jaw and a bottom jaw, the top and bottom jaws being operably coupled to the top and bottom handles to compress the top and bottom jaws toward each other responsive to compression of the top and bottom handles toward each other; and
an adjustment assembly that is adjustable to change a bite size defined by the jaw assembly,
wherein the adjustment assembly comprises an adjustment rod, an adjuster disposed at a distal end of the top handle and operably coupled to the adjustment rod, and a cross link extending between a portion of the bottom jaw or bottom handle and the adjustment rod,
wherein the adjuster comprises an eyelet from which the hand tool is suspendable via a tether, and
wherein rotating the adjuster correspondingly rotates the adjustment rod to change a point of intersection of the cross link and the adjustment rod along a longitudinal length of the adjustment rod without moving the eyelet axially toward or away from the distal end of the top handle.

13. The hand tool of claim 12, wherein the adjustment rod extends out of the top handle through a collar, and
wherein the adjuster is disposed proximate to the collar and relative position of the adjuster and collar is substantially constant during rotation of the adjuster to prevent withdrawal of the adjustment rod or the adjuster from engagement with the top handle.

14. A hand tool comprising:
a handle assembly comprising a top handle and a bottom handle;
a jaw assembly comprising a top jaw and a bottom jaw, the top and bottom jaws being operably coupled to the top and bottom handles to compress the top and bottom jaws toward each other responsive to compression of the top and bottom handles toward each other; and
an adjustment assembly that is adjustable to change a bite size defined by the jaw assembly,
wherein the adjustment assembly comprises a first adjuster disposed at a distal end of the top handle, a second adjuster disposed at a point between a middle portion and proximal end of the top handle, an adjustment rod operably coupled to each of the first and second adjusters, and a cross link extending between a portion of the bottom jaw or bottom handle and the adjustment rod,
wherein the second adjuster extends through a window portion disposed in the top handle, and
wherein the second adjuster exerts a force on the top handle at the window portion responsive to rotation of the adjustment rod to change a point of intersection of the cross link and the adjustment rod along a longitudinal length of the adjustment rod to change the bite size.

15. The hand tool of claim 14, wherein an adjustment rod interface member operably couples the cross link to the adjustment rod, and
wherein the adjustment rod interface member comprises a threaded channel in threaded engagement with the adjustment rod.

16. The hand tool of claim 14, wherein the second adjuster is affixed to the adjustment rod via a radially extending pin that passes through the second adjuster and into a portion of the adjustment rod.

17. The hand tool of claim 14, wherein a torsion spring is disposed between the bottom jaw and the cross link, the torsion spring having a neutral position and being compressed when the bite size in increased and extended when the bite size is decreased such that the torsion spring is biased to assist increasing and decreasing the bite size via rotation of the second adjuster with a same hand that grips the hand tool.

18. The hand tool of claim 14, wherein the bite size is adjustable while a grip hand of an operator engages the top and bottom handles via only the grip hand using the second adjuster, and via adjustment of the first adjuster using a non-grip hand of the operator.

19. A hand tool comprising:
a handle assembly comprising a top handle and a bottom handle;
a jaw assembly comprising a top jaw and a bottom jaw, the top and bottom jaws being operably coupled to the top and bottom handles to compress the top and bottom jaws toward each other responsive to compression of the top and bottom handles toward each other; and
an adjustment assembly that is adjustable to change a bite size defined by the jaw assembly,
wherein the adjustment assembly comprises an adjuster accessible through a window portion disposed in the top handle, an adjustment rod operably coupled to the adjuster to rotate with the adjuster, and a cross link extending between a portion of the bottom jaw or bottom handle and the adjustment rod, and
wherein a torsion spring is disposed between the bottom jaw and the cross link to assist increasing and decreasing the bite size via rotation of the adjuster with a same hand that grips the hand tool.

20. The hand tool of claim 19, wherein the torsion spring has a neutral position and is operably coupled to the bottom jaw and cross link to be compressed when the bite size is increased and extended when the bite size is decreased such that the torsion spring is biased to assist both increasing and decreasing the bite size via rotation of the adjuster.

21. The hand tool of claim 19, wherein the adjuster exerts a force on the top handle at the window portion responsive to rotation of the adjustment rod to change a point of intersection of the cross link and the adjustment rod along a longitudinal length of the adjustment rod to change the bite size.

22. The hand tool of claim 21, wherein an adjustment rod interface member operably couples the cross link to the adjustment rod,
wherein the adjustment rod interface member comprises a threaded channel in threaded engagement with the adjustment rod.

23. A hand tool comprising:
a handle assembly comprising a top handle and a bottom handle;
a jaw assembly comprising a top jaw and a bottom jaw, the top and bottom jaws being operably coupled to the top and bottom handles to compress the top and bottom jaws toward each other responsive to compression of the top and bottom handles toward each other;
an adjustment assembly that is adjustable to change a bite size defined by the jaw assembly; and
a locking assembly operably coupled to the bottom handle to lock a grip of the hand tool at the bite size responsive to actuation of the locking assembly,
wherein the locking assembly comprises a locking lever and a locking spring,
wherein the locking lever comprises a body portion that extends substantially within a channel formed in the bottom handle and an unlocking tab that is operable to actuate the locking assembly, and
wherein a shoulder portion is disposed at a transition between the body portion and the unlocking tab to provide tactile feedback to an operator of the hand tool to indicate a location at which the unlocking tab interfaces with the bottom handle when the locking assembly is actuated.
